(19) United States
(12) Patent Application Publication
(10) Pub. No.: US 2023/0364813 A1
(43) Pub. Date: Nov. 16, 2023

(54) Multifunctional Tool

(71) Applicant: BINOVO MANUFACTURING CO.,LTD, Jiangcheng District (CN)

(72) Inventors: Houkun LIANG, Yangjiang (CN); Qizhan MO, Yangjiang (CN); Huican ZHANG, Yangjiang (CN)

(21) Appl. No.: 18/195,949

(22) Filed: May 11, 2023

(30) Foreign Application Priority Data
May 11, 2022 (CN) 202221138532.8

(51) Int. Cl. B26B 11/00

(52) U.S. Cl. CPC B26B 11/003; B26B 11/001; B26B 11/008

(57) ABSTRACT

Some embodiments of the disclosure disclose a multifunctional tool. The multifunctional tool includes a first tool head, a second tool head, a first handle and a second handle, wherein the first handle comprises a first storage groove, the second handle comprises a second storage groove, the first tool head and the second tool head are hinged with each other, an end portion of the first tool head is rotationally connected with the first handle, an end portion of the second tool head is rotationally connected with the second handle, and the first tool head and the second tool head can be rotationally stored in the first storage groove and the second storage groove respectively; and the multifunctional tool is characterized by further including an electric screwdriver, the electric screwdriver is mounted in the second storage groove.

### TECHNICAL FIELD

The disclosure relates to a technical field of daily repair tools, and in particular to a multifunctional tool.

### BACKGROUND

With the booming development of smart homes, digital products and DIY markets, the functional components of multifunctional tool pliers on the current market are thick and short screwdrivers, which can only be manually operated, thereby making it difficult for users to efficiently dismount, mount and repair small household appliances, toys and digital products.

In the art known to inventors, a pair of multifunctional tool pliers, which is provided with a wrench having a plurality of functions, and various screwdrivers, and has the functions of various wrenches having planes and inner and outer hexagons, various tool pliers and a plurality of screwdrivers. However, all these screwdrivers need to be manually rotated to apply forces, thereby being inconvenient to operate and low in efficiency.

### SUMMARY

Some embodiments of the disclosure are to overcome the problems that the functional components of existing multifunctional tool pliers are thick and short screwdrivers, which need to be manually rotated to apply forces, resulting in inconvenient and laborious operations, and to provide a multifunctional tool with an electric screwdriver, which can enable a user to more efficiently dismount, mount and repair products such as small household appliances, toys and digital devices.

In order to achieve the above objectives, the technical solution utilized in the disclosure is: a multifunctional tool includes a first tool head, a second tool head, a first handle and a second handle, wherein the first handle includes a first storage groove, the second handle includes a second storage groove, the first tool head and the second tool head are hinged with each other, an end portion of the first tool head is rotationally connected with the first handle, an end portion of the second tool head is rotationally connected with the second handle, and the first tool head is rotationally stored in the first storage groove, and the second tool head is rotationally stored in the second storage groove; wherein the multifunctional tool further includes an electric screwdriver, and the electric screwdriver is disposed in the second storage groove.

In the above solution, the first tool head can be a first tong head, and the second tool head is a second tong head; or, the first tool head is a first shear blade, and the second tool head is a second shear blade; or, the first tool head and the second tool head are other tools that need to be used in cooperation with each other; the first tool head is rotationally connected with the first handle, so as to be stored in the first storage groove, and the second tool head is also rotationally connected with the second handle, so as to be stored in the second storage groove, so that the volume of the entire tool is relatively small in a storage state, and thus the purpose of portability can be achieved; and in the present disclosure, the first and second are only synonyms without specific restrictions, therefore the electric screwdriver can be disposed in the first storage groove and can also be disposed in the second storage groove. The multifunctional tool of the present disclosure includes, but is not limited to, the functions of the electric screwdriver and the functions of pliers and/or scissors, thereby being convenient for household repair of small household appliances.

In some embodiments, an end portion of the electric screwdriver is configured to protrude from an end portion of the second handle which is away from the second tool head. Since the end portion of the electric screwdriver is configured to protrude from the end portion of the second handle which is away from the second tool head, the use of the electric screwdriver can be facilitated, thereby avoiding interference caused by the second handle; and meanwhile, a storage function for the electric screwdriver is also formed.

In some embodiments, the electric screwdriver includes a housing assembly, a screwdriver head seat, a driving motor, a circuit assembly and a switch assembly, wherein the screwdriver head seat, the driving motor, the circuit assembly and the switch assembly are all disposed on the housing assembly, an end portion of the screwdriver head seat is configured to protrude from an end portion of the housing assembly, the switch assembly is configured to protrude from a side portion of the housing assembly, the housing assembly is disposed in the second storage groove, the driving motor is connected with the screwdriver head seat, and the driving motor is electrically connected with the circuit assembly, and the circuit assembly is further electrically connected with the switch assembly. On one hand, the housing assembly is configured to mount the screwdriver head seat, the driving motor, the circuit assembly and the switch assembly, and on the other hand, the housing assembly can also protect the above components, thereby improving the safety. The screwdriver head seat is configured to mount screwdriver heads of different specifications, including, but not limited to, flat-head screwdriver heads and cross-head screwdriver heads of different specifications and model numbers, so that the electric screwdriver can be suitable for repairing and dismounting different small household appliances; and specifically, the screwdriver heads and the screwdriver head seat are detachably connected, thereby facilitating the replacement of the screwdriver heads. The driving motor is configured to drive the screwdriver head seat to rotate, so as to realize mounting and dismounting functions of the electric screwdriver for screws. The circuit assembly is electrically connected with the driving motor to form circuit control, and the switch assembly is used for controlling the forward rotation and reverse rotation of the driving motor.

In some embodiments, the screwdriver head seat includes a screwdriver head sleeve, a transfer seat, a rolling shaft and a motor connecting seat, which are connected in sequence, the motor connecting seat is connected with the driving motor, and the screwdriver head seat comprises a magnetic attraction member which is further disposed in the screwdriver head sleeve. The screwdriver head sleeve is sleeved with the screwdriver heads, so as to mount and dismount the screwdriver heads of different specifications. The transfer seat is configured to connect the screwdriver head sleeve with the rolling shaft, and the rolling shaft is connected with the motor connecting seat, so that the driving motor can drive the screwdriver head sleeve to cause the screwdriver head to rotate. The magnetic attraction member adsorbs the screwdriver head by means of a magnetic force, thereby facilitating the mounting of the screwdriver head and the alignment of the screwdriver head with the head of a screw when the screw is mounted and dismounted, and thus improving the use convenience.

In some embodiments, the circuit assembly includes a rechargeable battery and a circuit board, and the circuit board is electrically connected with the rechargeable battery, the driving motor and the switch assembly, respectively. The circuit board is not only configured to charge the rechargeable battery, but also connecting the rechargeable battery with the driving motor, the switch assembly is configured to control the rotation and stop of the driving motor, the electric screwdriver is more convenient for household daily use by using the rechargeable battery, and the cost can be saved.

In some embodiments, the circuit board includes a first circuit board and a second circuit board, the first circuit board and the second circuit board are vertically arranged, the second circuit board is disposed on an end portion of the first circuit board and is welded with the first circuit board, the second circuit board includes a charging port, the circuit assembly comprises a metal conductive handle which is disposed on an end portion of the rechargeable battery, the first circuit board comprises a conductive interface, and the rechargeable battery is located below the first circuit board, and the metal conductive handle passes through the conductive interface to weld with the first circuit board. Since the first circuit board and the second circuit board are vertically arranged, more mounting space is saved on the basis of meeting the requirements of use functions; and by means of the conduction of the metal conductive handle, the rechargeable battery can be electrically connected with the first circuit board and the second circuit board.

In some embodiments, the housing assembly includes a cover plate, a first fixing seat and a second fixing seat, which are sequentially disposed, and the screwdriver head seat and the driving motor are both disposed on the second fixing seat; and the first fixing seat includes a battery mounting hole, the rechargeable battery is disposed on the second fixing seat and passes through the battery mounting hole, the first fixing seat is connected with the second fixing seat, and the cover plate covers the first fixing seat; and a cover plate comprises a charging mounting port to expose the charging port, by inserting a data line which passes through the charging mounting port into the charging port for charging. In order to enable the multifunctional tool of the present disclosure to meet portability, in terms of settings of the rechargeable battery, the volume of the rechargeable battery of the present disclosure is less than the volume of a common electric screwdriver, but in order to improve the cruising ability of the rechargeable battery, in a limited space, the rechargeable battery is made to be greater as much as possible, so that the screwdriver head seat and the driving motor are both disposed on the second fixing seat, but a part of the mounted rechargeable battery occupies the space of the first fixing seat, and a part occupies the space of the second fixing seat, so that the purpose of providing the battery mounting hole is to enable the rechargeable battery to have a greater mounting space; and the cover plate covers the first fixing seat, and by means of the cooperation of the cover plate, the first fixing seat and the second fixing seat, the mounting and fixing of the screwdriver head seat, the driving motor, the circuit assembly and the switch assembly are jointly achieved. The cover plate protects the charging port, and meanwhile, the charging mounting port is reserved to meet charging requirements.

In some embodiments, the first fixing seat includes a first limiting rib and a second limiting rib, the first limiting rib is configured to limit the screwdriver head seat, and the second limiting rib is configured to limit the driving motor; and the second fixing seat includes a third limiting rib and a fourth limiting rib, the third limiting rib is configured to limit the screwdriver head seat, and the fourth limiting rib is configured to limit the driving motor. The first limiting rib, the second limiting rib, the third limiting rib and the fourth limiting rib are configured to limit, so that the screwdriver head seat and the driving motor can be stably mounted and are not prone to displacement; and within the cognitive range of those skilled in the art, a limiting member for limiting the mounting of the rechargeable battery can be further disposed on the second fixing seat.

In some embodiments, wherein the housing assembly comprises a cover plate, and the switch assembly includes a shell, a forward rotation button and a reverse rotation button, the forward rotation button and the reverse rotation button are both electrically connected with the first circuit board, the cover plate includes a switch mounting hole, the shell is disposed above the forward rotation button and the reverse rotation button and protrudes from the switch mounting hole, and when the shell is pressed, the shell is abutted against the forward rotation button or the reverse rotation button. The shell is configured to provide a mounting space and protection for the switch assembly, the forward rotation button is electrically connected with the first circuit board to realize the forward rotation of the driving motor, and the reverse rotation button is electrically connected with the first circuit board to realize the reverse rotation of the driving motor; and specifically, by means of pressing the shell, the shell inclines towards the forward rotation button or inclines towards the reverse rotation button, such that the shell abuts against the forward rotation button or the reverse rotation button, so as to control the driving motor to perform forward rotation or reverse rotation.

In some embodiments, the multifunctional tool includes: one or more of a blade, a rope cutter, a bottle opener, scissors and a can opener, disposed on an end portion of the first handle which is away from the first tool head, and the blade, the rope cutter, the bottle opener, the scissors and the can opener are all rotationally connected with the first handle and can be stored in the first storage groove. The blade, the rope cutter, the bottle opener, the scissors and the can opener are all common small tools and are integrated in the multifunctional tool of the present utility model, thereby further improving the versatility, practicability and convenience of the present utility model.

The present disclosure is a multifunctional tool with an electric screwdriver, which has the functions of the electric screwdriver on the basis of realizing the functions of a common tool, so that the user can more efficiently dismount, mount and repair products such as small household appliances, toys and digital devices in a more labor-saving manner.

### BRIEF DESCRIPTION OF THE DRAWINGS

FIG. 1 illustrates a schematic structural diagram of a first use state of a multifunctional tool according to the disclosure.

FIG. 2 illustrates a schematic structural diagram of a storage state of a multifunctional tool according to the disclosure.

FIG. 3 illustrates a schematic structural diagram of a second use state of a multifunctional tool according to the disclosure.

FIG. 4 illustrates a mounting schematic diagram of an electric screwdriver and a second handle according to the disclosure.

FIG. 5 illustrates a schematic diagram of structural composition of an electric screwdriver according to the disclosure.

FIG. 6 illustrates a mounting schematic diagram of an electric screwdriver according to the disclosure.

FIG. 7 illustrates an exploded structural diagram of an electric screwdriver according to the disclosure.

The reference signs are illustrated as follows:

1. first tool head; 2. second tool head; 3. first handle; 4. second handle; 5. electric screwdriver; 51. housing assembly; 511. cover plate; 5111. switch mounting hole; 5112. charging mounting port; 512. first fixing seat; 513. second fixing seat; 5131. fourth limiting rib; 52. screwdriver head seat; 521. screwdriver head sleeve; 522. transfer seat; 523. rolling shaft; 524. motor connecting seat; 525. magnetic attraction member; 53. driving motor; 54. circuit assembly; 541. rechargeable battery; 5411. metal conducive handle; 542. first circuit board; 5421. conductive interface; 543. second circuit board; 5431. charging port; 55. switch assembly; 551. shell; 552. forward rotation button; 553. reverse rotation button; 61. blade; 62. rope cutter; 63. bottle opener; 64. scissors; 65. can opener.

### DETAILED DESCRIPTION OF THE EMBODIMENTS

The drawings are used for illustrative purposes only and cannot be construed as limitations to the present disclosure; in order to better illustrate the present embodiments, some components can be omitted, enlarged or reduced in the drawings, but do not represent the size of an actual product; and it can be understood by those skilled in the art that some well-known structures in the drawings and descriptions thereof can be omitted. The description of position relationships in the drawings is used for illustrative purposes only and cannot be construed as limitations to the present disclosure.

The same or similar reference signs in the drawings of the embodiments of the present disclosure correspond to the same or similar components; in the description of the present disclosure, it should be understood that orientation or position relationships indicated by the terms “upper”, “lower”, “left”, “right”, “long”, “short” and the like are based on orientation or position relationships shown in the drawings, are only used for the convenience of describing the present disclosure and simplifying the description, but do not indicate or imply that the referred apparatuses or elements must have specific orientations or must be constructed and operated in specific orientations. Therefore, the terms for describing the position relationships in the drawings are merely used for illustrative purposes and cannot be understood as limitations to the present patent, and those ordinary skilled in the art can understand the specific meanings of the foregoing terms according to specific situations.

The technical solutions of the present disclosure are further described below by means of specific embodiments and in combination with the drawings:

### Embodiment 1

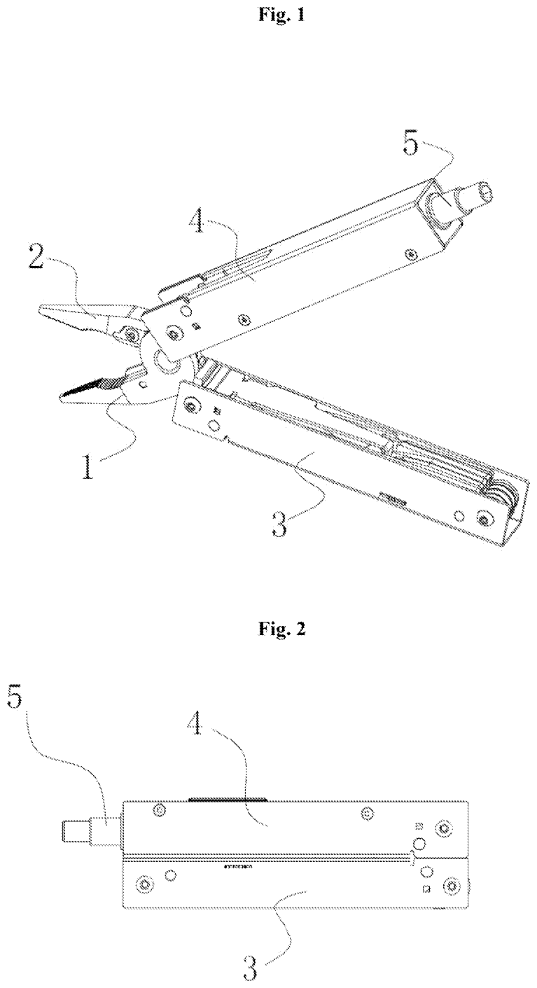

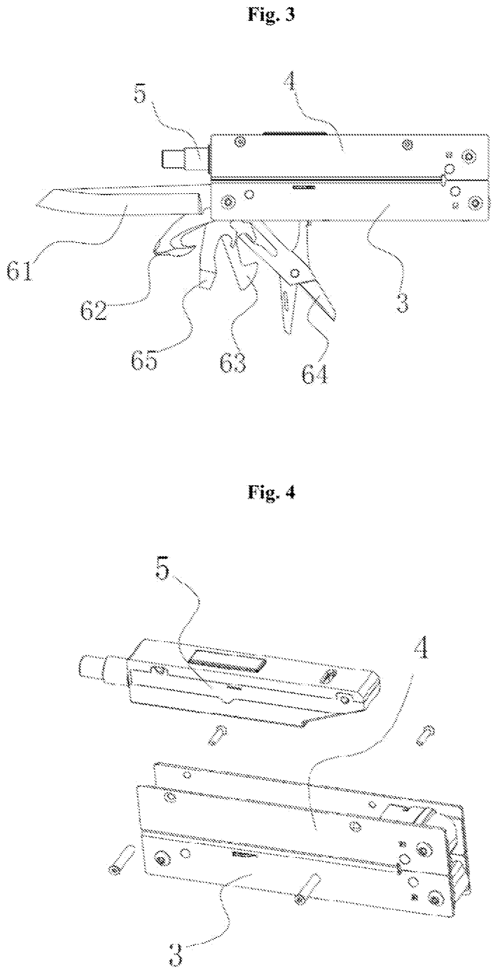

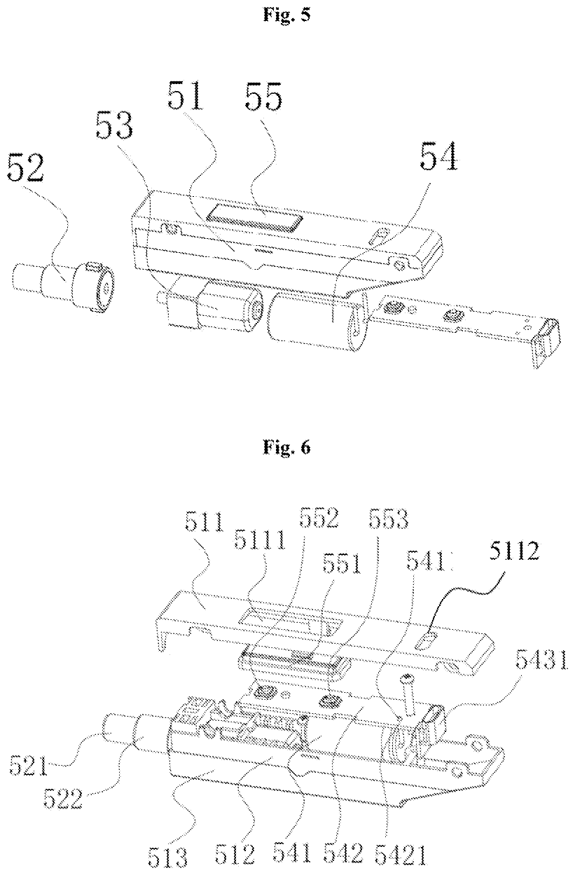

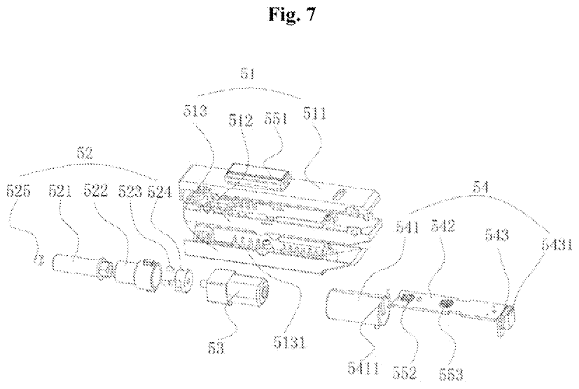

As shown in FIG. 1 to FIG. 7, a first embodiment of a multifunctional tool includes a first tool head 1, a second tool head 2, a first handle 3 and a second handle 4, wherein the first handle 3 includes a first storage groove, the second handle 4 includes a second storage groove, the first tool head 1 and the second tool head 2 are hinged with each other, an end portion of the first tool head 1 is rotationally connected with the first handle 3, an end portion of the second tool head 2 is rotationally connected with the second handle 4, and the first tool head 1 can be rotationally stored in the first storage groove, and the second tool head 2 can be rotationally stored in the second storage groove respectively; and specifically, the first tool head 1 is a first tong head, and the second tool head 2 is a second tong head; the multifunctional tool further includes an electric screwdriver 5, the electric screwdriver 5 is disposed in the second storage groove, and an end portion of the electric screwdriver 5 is configured to protrude from an end portion of the second handle 4 which is away from the second tool head 2. The electric screwdriver 5 includes a housing assembly 51, a screwdriver head seat 52, a driving motor 53, a circuit assembly 54 and a switch assembly 55, wherein the screwdriver head seat 52, the driving motor 53, the circuit assembly 54 and the switch assembly 55 are all disposed on the housing assembly 51, an end portion of the screwdriver head seat 52 is configured to protrude from an end portion of the housing assembly 51, the switch assembly 55 is configured to protrude from a side portion of the housing assembly 51, the housing assembly 51 is disposed in the second storage groove, the driving motor 53 is connected with the screwdriver head seat 52 and is electrically connected with the circuit assembly 54, and the circuit assembly 54 is further electrically connected with the switch assembly 55. The present disclosure is a pair of pliers having the functions of the electric screwdriver 5, so that the problem of dismounting and mounting screws can be solved more efficiently, and a user can more efficiently dismount, mount and repair products such as small household appliances, toys and digital devices. Moreover, by means of hiding the electric screwdriver 5 in the second storage groove, the storage space of the present utility model can be saved, and the tool integrating a plurality of functions better conforms to the requirements of the public.

As an improvement solution of the present embodiment, the screwdriver head seat 52 includes a screwdriver head sleeve 521, a transfer seat 522, a rolling shaft 523 and a motor connecting seat 524, which are connected in sequence, the motor connecting seat 524 is connected with the driving motor 53, and the screwdriver head seat includes a magnetic attraction member 525 which is further disposed in the screwdriver head sleeve 521. The screwdriver head sleeve 521 and the transfer seat 522 are both configured to protrude from the second handle 4, thereby avoiding the electric screwdriver 5 interfering with the second handle 4 in use, so that the screwdriver head has a greater activity space and is more suitable for occasions with small dismounting and mounting spaces.

As an improvement solution of the present embodiment, the circuit assembly 54 includes a rechargeable battery 541 and a circuit board, and the circuit board is electrically connected with the rechargeable battery 541, the driving motor 53 and the switch assembly 55, respectively. The circuit board includes a first circuit board 542 and a second circuit board 543, the first circuit board 542 and the second circuit board 543 are vertically arranged, the second circuit board 543 is arranged at an end portion of the first circuit board 542 and is welded with the first circuit board, the second circuit board 543 includes a charging port 5431, the circuit assembly includes a metal conductive handle 5411 which is disposed on an end portion of the rechargeable battery 541, the first circuit board 542 includes a conductive interface 5421, and the rechargeable battery 541 is located below the first circuit board 542, and the metal conductive handle passes through the conductive interface 5421 by means of the metal conductive handle 5411 so as to be electrically connected with the first circuit board 542. By means of externally connecting the charging port 5431 with a power supply, the rechargeable battery 541 can be charged by conducting the second circuit board 543 and the first circuit board 542, the shapes and positions of the first circuit board 542 and the second circuit board 543 are all related to the volumes and placement positions of the driving motor 53 and the rechargeable battery 541, so that the mounting space can be saved by reasonably setting the first circuit board 542 and the second circuit board 543, and thus the entire electric screwdriver 5 is more compact.

As an improvement solution of the present embodiment, the housing assembly 51 includes a cover plate 511, a first fixing seat 512 and a second fixing seat 513, which are sequentially arranged, and the screwdriver head seat 52 and the driving motor 53 are both arranged on the second fixing seat 513; and the first fixing seat 512 includes a battery mounting hole, the rechargeable battery 541 is disposed on the second fixing seat 513 and passes through the battery mounting hole, the first fixing seat 512 is connected with the second fixing seat 513, and the cover plate 511 covers the first fixing seat 512. A cover plate 511 includes a charging mounting port 5112 to expose the charging port 5431, by inserting a data line which passes through the charging mounting port 5112 into the charging port 5431 for charging. In some embodiments, the first fixing seat 512 includes a first limiting rib and a second limiting rib, the first limiting rib is configured to limit the screwdriver head seat 52, and the second limiting rib is configured to limit the driving motor 53; and the second fixing seat 513 includes a third limiting rib and a fourth limiting rib, the third limiting rib is configured to limit the screwdriver head seat 52, and the fourth limiting rib 5131 is configured to limit the driving motor 53. The switch assembly 55 includes a shell 551, a forward rotation button 552 and a reverse rotation button 553, the forward rotation button 552 and the reverse rotation button 553 are both electrically connected with the first circuit board 542, the cover plate 511 includes a switch mounting hole 5111, the shell 551 is disposed above the forward rotation button 552 and the reverse rotation button 553 and protrudes from the switch mounting hole 5111, and when the shell 551 is pressed, the shell can abut against the forward rotation button 552 or the reverse rotation button 553. The first fixing seat 512 and the second fixing seat 513 include buckles and clamping grooves to realize clamping.

The assembly process of the electric screwdriver 5 is as follows: electrically connecting the forward rotation button 552 and the reverse rotation button 553 with the first circuit board 542, connecting the first circuit board 542 with the rechargeable battery 541 by means of the metal conductive handle 5411 and the conductive interface 5421, then connecting the second circuit board 543 with the first circuit board 542, next, mounting the rechargeable battery 541 on the second fixing seat 513, assembling the screwdriver head seat 52 and the driving motor 53 on the second fixing seat 513, and clamping the first fixing seat 512 with the second fixing seat 513; and then covering the cover plate 511 on the first fixing seat 512, inserting the shell 551 from the switch mounting hole 5111, and at this time, both the shell 551 and the charging port 5431 are exposed from the outer side of the housing assembly 51.

In some embodiments, the multifunctional tool further includes one or more of a blade 61, a rope cutter 62, a bottle opener 63, scissors 64 and a can opener 65, one or more of a blade 61, a rope cutter 62, a bottle opener 63, scissors 64 and a can opener 65 disposed on an end portion of the first handle 3 which is away from the first tool head 1, and the blade 61, the rope cutter 62, the bottle opener 63, the scissors 64 and the can opener 65 are all rotationally connected with the first handle 3 and can be stored in the first storage groove. The versatility and practicability of the multifunctional tool of the present disclosure are improved by the blade 61, the rope cutter 62, the bottle opener 63, the scissors 64 and the can opener 65, and when the electric screwdriver 5 is disposed on the first handle 3, the plurality of tools can also be disposed on the second handle 4 for staggered setting.

### Embodiment 2

The following shows Embodiment 2 of a multifunctional tool according to the present disclosure, the present embodiment is similar to Embodiment 1, except that the first tool head 1 is a first shear blade, and the second tool head 2 is a second shear blade. The first shear blade and the second shear blade can realize the functions of the scissors 64, and in combination with the electric screwdriver 5, the scissors 64 with the electric screwdriver 5 are formed in the present disclosure.

### Embodiment 3

The following shows Embodiment 3 of a multifunctional tool according to the present disclosure, the present embodiment is similar to Embodiment 1, except that the multifunctional tool further includes several screwdriver heads of different types and different specifications, and the above screwdriver heads can all be stored in the first storage groove or the second storage groove. In use, the screwdriver head is sleeved with the screwdriver head sleeve 521, and then the screwdriver head can be rotated by controlling the switch assembly 55, so as to complete mounting and dismounting functions of a screw. Of course, in order to reduce the volume of the multifunctional tool of the present disclosure, the above screwdriver heads can also be stored with an additional storage box instead of being stored in the first storage groove or the second storage groove.

Obviously, the above embodiments of the present disclosure are merely examples listed for clearly illustrating the present disclosure, rather than limiting the embodiments of the present disclosure. For those ordinary skilled in the art to which the present utility model belongs, other different forms of changes or variations can also be made on the basis of the above description. There is no need to exhaust all embodiments herein. Any modifications, equivalent replacements, improvements and the like, made within the spirit and principles of the present utility model, shall all fall within the protection scope of the claims of the present disclosure.

What is claimed is:

1. A multifunctional tool, comprising a first tool head, a second tool head, a first handle and a second handle, wherein the first handle comprises a first storage groove, the second handle comprises a second storage groove, the first tool head and the second tool head are hinged with each other, an end portion of the first tool head is rotationally connected with the first handle, an end portion of the second tool head is rotationally connected with the second handle; the first tool head is rotationally stored in the first storage groove, and the second tool head is rotationally stored in the second storage groove; wherein the multifunctional tool further comprises an electric screwdriver, and the electric screwdriver is disposed in the second storage groove.

2. The multifunctional tool as claimed in claim 1, wherein the electric screwdriver comprises a housing assembly, a screwdriver head seat, a driving motor, a circuit assembly and a switch assembly, the screwdriver head seat, the driving motor, the circuit assembly and the switch assembly are all disposed on the housing assembly, an end portion of the screwdriver head seat is configured to protrude from an end portion of the housing assembly, the switch assembly is configured to protrude from a side portion of the housing assembly, the housing assembly is disposed in the second storage groove, the driving motor is connected with the screwdriver head seat, and the driving motor is electrically connected with the circuit assembly, and the circuit assembly is further electrically connected with the switch assembly.

3. The multifunctional tool as claimed in claim 2, wherein the screwdriver head seat comprises a screwdriver head sleeve, a transfer seat, a rolling shaft and a motor connecting seat, which are connected in sequence, the motor connecting seat is connected with the driving motor, and the screwdriver head seat comprises a magnetic attraction member which is disposed in the screwdriver head sleeve.

4. The multifunctional tool as claimed in claim 2, wherein the circuit assembly comprises a rechargeable battery and a circuit board, and the circuit board is electrically connected with the rechargeable battery, the driving motor and the switch assembly, respectively.

5. The multifunctional tool as claimed in claim 4, wherein the circuit board comprises a first circuit board and a second circuit board, the first circuit board and the second circuit board are vertically arranged, the second circuit board is disposed on an end portion of the first circuit board and is welded with the first circuit board, the second circuit board comprises a charging port, the circuit assembly comprises a metal conductive handle which is disposed on an end portion of the rechargeable battery, the first circuit board comprises a conductive interface; the rechargeable battery is located below the first circuit board, and the metal conductive handle passes through the conductive interface to weld with the first circuit board.

6. The multifunctional tool as claimed in claim 5, wherein the housing assembly comprises a cover plate, a first fixing seat and a second fixing seat, which are sequentially disposed, and the screwdriver head seat and the driving motor are both disposed on the second fixing seat; and the first fixing seat comprises a battery mounting hole, the rechargeable battery is disposed on the second fixing seat and passes through the battery mounting hole, the first fixing seat is connected with the second fixing seat, and the cover plate covers the first fixing seat; the cover plate comprises a charging mounting port to expose the charging port, by inserting a data line which passes through the charging mounting port into the charging port for charging.

7. The multifunctional tool as claimed in claim 6, wherein the first fixing seat comprises a first limiting rib and a second limiting rib, the first limiting rib is configured to limit the screwdriver head seat, and the second limiting rib is configured to limit the driving motor; the second fixing seat comprises a third limiting rib and a fourth limiting rib, the third limiting rib is configured to limit the screwdriver head seat, and the fourth limiting rib is configured to limit the driving motor.

8. The multifunctional tool as claimed in claim 5, wherein the housing assembly comprises a cover plate, and the switch assembly comprises a shell, a forward rotation button and a reverse rotation button, the forward rotation button and the reverse rotation button are both electrically connected with the first circuit board, the cover plate comprises a switch mounting hole, the shell is disposed above the forward rotation button and the reverse rotation button and protrudes from the switch mounting hole, and when the shell is pressed, the shell is abutted against the forward rotation button or the reverse rotation button.

9. The multifunctional tool as claimed in claim 1, wherein the first tool head is a first tong head, and the second tool head is a second tong head; or, the first tool head is a first shear blade, and the second tool head is a second shear blade.

10. The multifunctional tool as claimed in claim 2, wherein the first tool head is a first tong head, and the second tool head is a second tong head; or, the first tool head is a first shear blade, and the second tool head is a second shear blade.

11. The multifunctional tool as claimed in claim 3, wherein the first tool head is a first tong head, and the second tool head is a second tong head; or, the first tool head is a first shear blade, and the second tool head is a second shear blade.

12. The multifunctional tool as claimed in claim 4, wherein the first tool head is a first tong head, and the second tool head is a second tong head; or, the first tool head is a first shear blade, and the second tool head is a second shear blade.

13. The multifunctional tool as claimed in claim 5, wherein the first tool head is a first tong head, and the second tool head is a second tong head; or, the first tool head is a first shear blade, and the second tool head is a second shear blade.

14. The multifunctional tool as claimed in claim 6, wherein the first tool head is a first tong head, and the second tool head is a second tong head; or, the first tool head is a first shear blade, and the second tool head is a second shear blade.

15. The multifunctional tool as claimed in claim 7, wherein the first tool head is a first tong head, and the second tool head is a second tong head; or, the first tool head is a first shear blade, and the second tool head is a second shear blade.

16. The multifunctional tool as claimed in claim 8, wherein the first tool head is a first tong head, and the second tool head is a second tong head; or, the first tool head is a first shear blade, and the second tool head is a second shear blade.

17. The multifunctional tool as claimed in claim 9, wherein the multifunctional tool comprises:
one or more of a blade, a rope cutter, a bottle opener, scissors and a can opener, disposed on an end portion of the first handle which is away from the first tool head, and the rope cutter, the bottle opener, the scissors and the can opener are all rotationally connected with the first handle and can be stored in the first storage groove.
